(19) United States
(12) Patent Application Publication
(10) Pub. No.: US 2023/0169576 A1
(43) Pub. Date: Jun. 1, 2023

(54) VEHICLE ORDER PROCESSING METHOD, APPARATUS AND SYSTEM, AND STORAGE MEDIUM

(71) Applicants: Fuzhou BOE Optoelectronics Technology Co., Ltd., Fuzhou, Fujian (CN); BOE Technology Group Co., Ltd., Beijing (CN)

(72) Inventors: Chenxu HUANG, Beijing (CN); Xin SHEN, Beijing (CN)

(21) Appl. No.: 17/922,461

(22) PCT Filed: Feb. 24, 2021
(86) PCT No.: PCT/CN2021/077686

§ 371 Date: Oct. 31, 2022

(30) Foreign Application Priority Data
May 15, 2020 (CN) 202010415453.6

(51) Int. Cl. G06Q 30/0601

(52) U.S. Cl. CPC G06Q 30/0637

(57) ABSTRACT

Provided are a vehicle order processing method, apparatus and a system, and a storage medium. The vehicle order processing method includes: an information server receives a first confirmation request carrying an order number and sent by a freight forwarder device; when it is confirmed that the order number is valid, send first confirmation-passed information to the freight forwarder device; when receiving the first confirmation-passed information, the freight forwarder device sends a vehicle order to the information server, the vehicle order comprising order-related information and vehicle-related information; and the information server examines and approves the vehicle order, and sends the vehicle order to an entrance guard device after the vehicle order is approved.

### CROSS REFERENCE TO RELATED APPLICATION

The present disclosure claims the right of priority to Chinese patent application No. 202010415453.6, filed to the Chinese Patent Office on May 15, 2020 and entitled “Vehicle order processing method, apparatus and system, and storage medium”, which is incorporated in its entirety herein by reference.

### FIELD

The present disclosure relates to the technical field of vehicle orders, and particularly relates to a vehicle order processing method, apparatus and system, and a storage medium.

### BACKGROUND

As enterprises keep developing, their storage property value also keeps growing with an increasing number of high-value light-weight materials and finished products, so the issue of property theft prevention becomes more urgent.

At present, logistics vehicles of the enterprise are uniformly coordinated by a logistics department. At first, the logistics department informs a supplier or a freight forwarder company through mail notification, the vehicle will enter a factory area after offline vehicle dispatch or random reservation in an application (APP) by a third-party company, but the third-party company may reuse a previous reservation order number to reserve the vehicle, causing high safety risk to the factory area. Moreover, after arriving at the factory area, the vehicle is allowed to enter the factory area for operation only after being repeatedly confirmed by the logistics department, the supplier, a storehouse and an entrance guard, so the flow of the vehicle entering the factory area is tedious.

### SUMMARY

In a first aspect, a vehicle order processing method provided in an embodiment of the present disclosure is used for an information server and includes:

receiving a first confirmation request carrying an order number and sent by a freight forwarder device;

sending a first confirmation pass information to the freight forwarder device in response to the order number being determined to be valid;

receiving a vehicle order sent by the freight forwarder device according to the first confirmation pass information, the vehicle order including an order-related information and a vehicle-related information; and

examining and approving the vehicle order, and sending the vehicle order to an entrance guard device after the vehicle order is approved.

In a possible implementation, the above vehicle order processing method provided in an embodiment of the present disclosure further includes:

determining whether a quantity of an article in an order corresponding to the order number is cleared to zero, in response to the quantity of the article changing;

setting a state of the order number as valid in response to the quantity of the article not being cleared to zero;

setting the state of the order number as invalid, in response to the quantity of the article being cleared to zero; and

re-determining validity of the order number in response to the order corresponding to the order number being subjected to preset operation, the preset operation comprising an order modification or an order closing.

In a possible implementation, before the receiving a first confirmation request carrying an order number and sent by a freight forwarder device, the method further includes:

generating the order number according to a preset condition, the preset condition including that a procurement is approved and/or a delivery is approved, and the order number being configured to trigger the freight forwarder device to send the first confirmation request.

In a possible implementation, the vehicle order further includes vehicle reservation person information; and

the examining and approving the vehicle order includes:

sending an examination-approval request to an examination-approval end corresponding to the vehicle reservation person information, and receiving an examination and approval result sent by the examination-approval end.

In a second aspect, a vehicle order processing apparatus further provided in an embodiment of the present disclosure is used for an information server and includes:

a first reception module configured to receive a first confirmation request carrying an order number and sent by a freight forwarder device,

a first confirmation module configured to send a first confirmation pass information to the freight forwarder device in response to the order number being determined to be valid,

the first reception module being further configured to receive a vehicle order sent by the freight forwarder device according to the first confirmation pass information, the vehicle order including an order-related information and a vehicle-related information, and

a first processing module configured to examine and approve the vehicle order, and send the vehicle order to an entrance guard device after the vehicle order is approved.

In a possible implementation, the above vehicle order processing apparatus provided in an embodiment of the present disclosure further includes:

an order number state determination module configured to determine, in response to the quantity of an article in an order corresponding to the order number changing, whether the quantity of the article is cleared to zero; set a state of the order number as valid in response to the quantity of the article not being cleared to zero; set the state of the order number as invalid in response to the quantity of the article being cleared to zero; and re-determine, in response to the order corresponding to the order number being subjected to preset operation, validity of the order number, the preset operation comprising an order modification or an order closing.

In a possible implementation, the above vehicle order processing apparatus provided in an embodiment of the present disclosure further includes:

an order number generation module configured to generate the order number according to a preset condition, the preset condition including that procurement is a approved and/or a delivery is approved, and the order number being configured to trigger the freight forwarder device to send the first confirmation request.

In a possible implementation, the vehicle order further includes vehicle reservation person information; and

the first processing module is configured to send an examination-approval request to an examination-approval end corresponding to the vehicle reservation person information, and receive an examination and approval result sent by the examination-approval end.

In a third aspect, a vehicle order processing method further provided in an embodiment of the present disclosure is used for a freight forwarder device and includes:

sending a first confirmation request carrying an order number to an information server;

receiving a first confirmation pass information sent in response to the information server confirming that the order number is valid;

sending a vehicle order to the information server, the vehicle order including an order-related information and a vehicle-related information; and causing the information server examine and approve the vehicle order and send the vehicle order to an entrance guard device after the vehicle order is approved.

In a possible implementation, the sending a first confirmation request carrying an order number to an information server includes: receiving the order-related information including the order number at a first interface, and sending the first confirmation request based on the order-related information; and

the sending a vehicle order to the information server includes:

in response to the first confirmation pass information being received, displaying a second interface, receiving the vehicle-related information at the second interface,

generating the vehicle order according to the order-related information and the vehicle-related information, and sending the vehicle order.

In a fourth aspect, a vehicle order processing apparatus further provided in an embodiment of the present disclosure is used for a freight forwarder device and includes:

a first sending module configured to send a first confirmation request carrying an order number to an information server;

a second reception module configured to receive a first confirmation pass information sent by the information server in response to the information server confirming the order number is valid; and

a second processing module configured to send a vehicle order to the information server, the vehicle order including an order-related information and a vehicle-related information; and cause the information server examine and approve the vehicle order and send the vehicle order to an entrance guard device after the vehicle order is approved.

In a possible implementation, the first sending module is configured to receive the order-related information including the order number at a first interface, and send the first confirmation request based on the order-related information; and

the second processing module is specifically configured to display a second interface in response to the first confirmation pass information being received, receive the vehicle-related information at the second interface, generate the vehicle order according to the order-related information and the vehicle-related information, and send the vehicle order.

In a fifth aspect, a vehicle order processing method further provided in an embodiment of the present disclosure is used for an entrance guard device and includes:

receiving a vehicle order sent by an information server, the vehicle order including an order-related information and a vehicle-related information; and

displaying the vehicle order, the vehicle order being set to indicate that a vehicle waiting for entry should be verified.

In a possible implementation, the above vehicle order processing method provided in an embodiment of the present disclosure further includes:

recording a vehicle entry-related information, and displaying the vehicle entry-related information at a third interface, the vehicle entry-related information including a license plate, a vehicle entering time, a destination of a vehicle and a real-time state of the vehicle.

In a sixth aspect, a vehicle order processing apparatus further provided in an embodiment of the present disclosure is used for an entrance guard device and includes:

a first reception module configured to receive a vehicle order sent by an information server, the vehicle order including an order-related information and a vehicle-related information; and

a first display module configured to display the vehicle order, the vehicle order being set to indicate that a vehicle waiting for entry should be verified.

In a possible implementation, the above vehicle order processing apparatus provided in an embodiment of the present disclosure further includes:

an information display module configured to record vehicle entry-related information, and display the information at a third interface, the vehicle entry-related information including a license plate, a vehicle entering time, a destination of a vehicle and a real-time state of the vehicle.

In a seventh aspect, a vehicle order processing system further provided in an embodiment of the present disclosure includes: an information server, a freight forwarder device and an entrance guard device, where the information server is in communication connection with the freight forwarder device and the entrance guard device;

the information server is configured to receive a first confirmation request carrying an order number and sent by the freight forwarder device, send first confirmation pass information to the freight forwarder device in response to the order number being determined to be valid, receive a vehicle order sent by the freight forwarder device according to the first confirmation pass information, examine and approve the vehicle order, and send the vehicle order to the entrance guard device after the vehicle order is approved, and the vehicle order includes order-related information and vehicle-related information;

the freight forwarder device is configured to send the first confirmation request carrying the order number to the information server, receive the first confirmation pass information sent in response to the information server confirming that the order number is valid, and send the vehicle order to the information server; and

the entrance guard device is configured to receive the vehicle order sent by the information server and display the vehicle order, the vehicle order being set to indicate that a vehicle waiting for entry should be verified.

In an eighth aspect, an electronic device further provided in an embodiment of the present disclosure includes:

a processor;

a memory electrically connected to the processor; and

at least one program stored in the memory and configured to be executed by the processor, the at least one program being configured to implement the vehicle order processing method of the first aspect, the vehicle order processing method of the third aspect, or the vehicle order processing method of the fifth aspect.

In a ninth aspect, a computer-readable storage medium further provided in an embodiment of the present disclosure is used for storing a computer instruction, where when running on a computer, the computer instruction implements the vehicle order processing method of the first aspect, the vehicle order processing method of the third aspect, or the vehicle order processing method of the fifth aspect.

### BRIEF DESCRIPTION OF THE DRAWINGS

FIG. 1 is a block diagram of a vehicle order processing system provided in an embodiment of the present disclosure;

FIG. 2 is a flowchart of a vehicle order processing method provided in an embodiment of the present disclosure;

FIG. 3 is a flowchart of another vehicle order processing method provided in an embodiment of the present disclosure;

FIG. 4 is a block diagram of a vehicle order processing apparatus provided in an embodiment of the present disclosure;

FIG. 5 is a flowchart of yet another vehicle order processing method provided in an embodiment of the present disclosure;

FIG. 6 is a block diagram of another vehicle order processing apparatus provided in an embodiment of the present disclosure;

FIG. 7 is a flowchart of still another vehicle order processing method provided in an embodiment of the present disclosure;

FIG. 8 is a block diagram of yet another vehicle order processing apparatus provided in an embodiment of the present disclosure; and

FIG. 9 is a flowchart of still another vehicle order processing method provided in an embodiment of the present disclosure.

### DETAILED DESCRIPTION OF THE EMBODIMENTS

The present disclosure will be described in detail below, examples of embodiments of the present disclosure will be illustrated in the drawings, and the same or similar reference numerals refer to the same or similar components or components having the same or similar function throughout. Further, under the condition that a detailed description of the known art is unnecessary for the illustrated features of the present disclosure, it will be omitted. The embodiments described below by reference to the drawings are illustrative only for explaining the present disclosure and are not to be construed as limiting the present disclosure.

Those skilled in the art will understand that unless otherwise defined, all terms (including technical and scientific terms) used herein have the same meanings usually understood by those of ordinary skill in the field of the present disclosure. It will be further understood that terms, such as those defined in commonly used dictionaries, should be interpreted as having a meaning that is consistent with their meaning in the context of the relevant art and will not be interpreted in an idealized or overly formal sense unless specifically defined herein.

As used herein, the singular forms “a”, “one”, “the”, and “this” can be understood by those skilled in the art to include the plural forms as well, unless specifically stated otherwise. It will be further understood that the term “include” used in this specification of the present disclosure specifies the presence of the features, integers, steps, operations, elements, and/or components, but do not excludes the presence or addition of one or more other features, integers, steps, operations, elements, components, and/or groups thereof. It will be understood that when an element is referred to as being “connected” or “coupled” to another element, it can be directly connected or coupled to the element or intermediate elements can also be present. Further, “connected” or “coupled” as used herein can include wirelessly connected or wirelessly coupled. As used herein, the phrase “and/or” includes all or any element and all combinations of one or more of the associated listed items.

The technical solutions of the present disclosure and how the technical solutions of the present disclosure solve the above-described technical problem are described in detail below with specific embodiments.

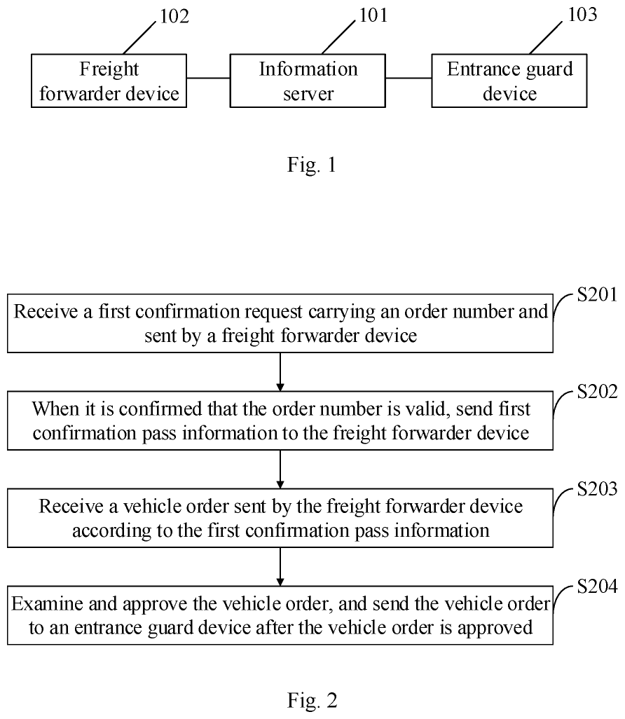

A vehicle order processing system is provided in an embodiment of the present disclosure. With reference to FIG. 1, the vehicle order processing system includes: an information server 101, a freight forwarder device 102 and an entrance guard device 103, where the information server 101 is in communication connection with the freight forwarder device 102 and the entrance guard device 103.

The information server 101 is configured to receive a first confirmation request carrying an order number and sent by the freight forwarder device 102, and send first confirmation pass information to the freight forwarder device when it is confirmed that the order number is valid; and receive a vehicle order sent by the freight forwarder device according to the first confirmation pass information, examine and approve the vehicle order, and send the vehicle order to the entrance guard device 103 after the vehicle order is approved; the vehicle order includes order-related information and vehicle-related information.

The freight forwarder device 102 is configured to send the first confirmation request carrying the order number to the information server, receive the first confirmation pass information sent when the information server confirms that the order number is valid, and send the vehicle order to the information server.

The entrance guard device 103 is configured to receive the vehicle order sent by the information server 101 and display the vehicle order; and the vehicle order is set to indicate that a vehicle waiting for entry should be verified.

Optionally, the freight forwarder device 102 may be a mobile terminal such as a smartphone, a computer, a handheld terminal, etc. configured to input the order-related information and the vehicle-related information, and generate and display the vehicle order.

The vehicle order processing system in an embodiment of the present disclosure includes the information server 101, the freight forwarder device 102 and the entrance guard device 103, where the information server 101 is in communication connection with the freight forwarder device 102 and the entrance guard device 103, the information server 101 confirms whether the order number in the first confirmation request sent by the freight forwarder device 102 is valid, after it is confirmed that the order number is valid, the freight forwarder device 102 sends a vehicle order to the information server 101, the information server 101 examines and approves the vehicle order, and sends the vehicle order to the entrance guard device 103 under the condition that the vehicle order is approved, such that the entrance guard device 103 verifies the vehicle waiting for entry by means of the vehicle order. According to this embodiment of the present disclosure, on the basis of the information server 101, the freight forwarder device 102, and the entrance guard device 103, a safer and faster factory entrance reservation process is provided for logistics vehicles, thereby improving the timeliness, safety, and convenience of logistics vehicle reservations.

According to some embodiments of the present disclosure, the order number may be allowed to initiate order reservation only under the condition that the order number is confirmed to be valid by the information server 101, that is, a driver may not make reservation to enter a factory area with a previous order number, and vehicles entering the factory area submit vehicle-related information in advance at the information server 101, so as to avoid the situation that the vehicles which do not make reservation in advance enter the factory area, and compared with other factory entrance reservation modes, the safety risk is greatly reduced under the condition that human resource capital is not increased.

According to the vehicle order in this embodiment of the present disclosure, the vehicle and the order number are bound and sent to the entrance guard device 103 by means of the information server 101 in advance, such that the order number and vehicle-related information arrive at an entrance guard ahead of the vehicle, information is transmitted in time, and the entrance guard may verify the vehicle waiting for entry according to the vehicle order, such that the technical problem of a tedious process of vehicles entering the factory area in the prior art is solved.

The vehicle order in some embodiments of the present disclosure may include vehicle reservation person information, such that the vehicle-related information may be sent to an examination-approval end corresponding to the vehicle reservation person information for examination and approval. That is, the vehicle order may be directly submitted to an actual reservation person, and the actual reservation person examines and approves the vehicle order, such that invalid operation content is greatly reduced.

According to some embodiments of the present disclosure, the information server 101 sends the order number to the freight forwarder device 102 in advance, and the vehicle order is possibly generated under the condition that the order number is valid, so as to control part of invalid work and reduce the invalid work.

According to some embodiments of the present disclosure, on the basis of three-party linkage and real-time data synchronization of the information server 101, the freight forwarder device 102 and the entrance guard device 103, under the condition that no labor cost is increased, the factory entrance safety risk of the external logistics vehicles is greatly reduced, a factory entrance waiting time of the vehicle is optimized, and thus the factory area business may be carried out more smoothly. Some embodiment of the present disclosure does not need to rely on a global positioning system (GPS) and radio frequency identification (RFID) like other technical solutions, is safer and more convenient to operate, and does not generate hardware investment cost.

Optionally, the information server 101 is further configured to determine, when it is detected that the quantity of an article in the order corresponding to the order number changes, whether the quantity of the article in the order corresponding to the order number is cleared to zero; set, under the condition that the quantity of the article in the order corresponding to the order number is not cleared to zero, a state of the order number as valid; set, under the condition that the quantity of the article in the order corresponding to the order number is cleared to zero, the state of the order number as invalid; and re-determine, when the order corresponding to the order number is driven to be subjected to preset operation, validity of the order number, the preset operation including order modification or order closing. The condition that the quantity of the article in the order corresponding to the order number is not cleared to zero means that the quantity of the article in the order corresponding to the order number is greater than the increased or decreased quantity of the article. The quantity of the article changes when the article is purchased or delivered, and the quantity of the article is correspondingly increased or decreased in the system according to the quantity change of the purchased or delivered article each time.

Optionally, the information server 101 is further configured to generate the order number according to a preset condition and send the order number to the freight forwarder device 102, the preset condition including that procurement is approved and/or delivery is approved.

Optionally, the condition that the order number is valid needs to satisfy requirements that the order number is approved and the quantity of the article in the order corresponding to the order number is not cleared to zero, and the condition that the quantity of the article is not cleared to zero means that the preset quantity of the article is greater than the quantity of the incoming or outgoing article.

Optionally, the vehicle order further includes: vehicle reservation person information; the information server 101 is further configured to send an examination-approval request to an examination-approval end corresponding to the vehicle reservation person information, and receive an examination and approval result sent by the examination-approval end.

Optionally, the freight forwarder device 102 is configured to receive the order-related information including the order number at a first interface, send the first confirmation request based on the order-related information, display a second interface when the first confirmation pass information is received, receive the vehicle-related information at the second interface, generate the vehicle order according to the order-related information and the vehicle-related information, and send the vehicle order.

Optionally, the WeChat official account, applet, or other software in the freight forwarder device 102 is configured to execute the steps of the vehicle order processing method.

Optionally, the entrance guard device 103 is further configured to record vehicle entry-related information, and display the information at a third interface, the vehicle entry-related information including a license plate, a vehicle entering time, a destination of a vehicle and a real-time state of the vehicle.

Optionally, the entrance guard device 103 is further configured to send a second confirmation request, such that the information server 101 confirms whether an order number in the second confirmation request is valid, and under the condition that the order number is valid, second confirmation pass information is sent. When the second confirmation pass information is received, the vehicle waiting for entry is verified according to the vehicle-related information of the vehicle order.

Based on the same inventive concept, an embodiment of the present disclosure provides a vehicle order processing method used for an information server 101. With reference to FIG. 2, the vehicle order processing method includes following steps.

S201, a first confirmation request carrying an order number and sent by a freight forwarder device is received. Optionally, the first confirmation request may include an order number and may further include order-related information, and the order-related information may include information, for example, a title and an order type.

S202, when it is confirmed that the order number is valid, first confirmation pass information is sent to the freight forwarder device.

Optionally, under the condition that it is determined that the order number is invalid, first confirmation failure information is sent to the freight forwarder device, and when receiving the first confirmation failure information, the freight forwarder device displays prompt information similar to “the order number does not exist, please confirm whether the order number is wrong”.

S203, a vehicle order sent by the freight forwarder device according to the first confirmation pass information is received, and the vehicle order may include order-related information and vehicle-related information.

Optionally, the order-related information in the vehicle order may include an order number, an order title, an order type, the number of order numbers, a cause, etc. The vehicle-related information in the vehicle order may include a logistics company, a driver name, a driver identity card, contact information, a license plate, a vehicle model, an access door, a destination, a deliveryman, an estimated time, etc.

S204, the vehicle order is examined and approved, and the vehicle order is sent to an entrance guard device after the vehicle order is approved.

In some embodiments, the vehicle order sent by the freight forwarder device may further include: vehicle reservation person information. Correspondingly, the step that the vehicle order is examined and approved may include: examination and approval is sent to an examination-approval end corresponding to the vehicle reservation person information, and an examination and approval result sent by the examination-approval end is received.

Optionally, the vehicle reservation person information may be vehicle reservation person information automatically filled by the freight forwarder device after it is confirmed that the order number is valid and the information server sends first confirmation pass information to the freight forwarder device, or may be vehicle reservation person information sent by carrying the vehicle reservation person information and the order number together in the first confirmation request by the freight forwarder device before it is confirmed that the order number is valid.

Optionally, when the vehicle order is examined and approved, under the condition that the vehicle order fails to be approved, approval failure information is sent to the freight forwarder device, and the vehicle order is set as invalid. Under the condition that the vehicle order is approved, approval passing information may be sent to the freight forwarder device, and the state of the vehicle order is set as valid. Or, under the condition that the vehicle order is approved, no approval passing information is sent to the freight forwarder device, and when the freight forwarder device receives no approval failing information, the vehicle order is automatically set as valid.

Optionally, the information server sends the approved vehicle order to the entrance guard device, and the entrance guard device may check the vehicle order sent by the information server and confirm whether vehicle reservation is successful by means of the vehicle order. Moreover, the entrance guard device may verify the vehicle waiting for entering according to the vehicle-related information of the vehicle order. For example, when a driver arrives at a factory area, driver identity card may be scanned so as to confirm that the driver information is consistent with driver information in the vehicle-related information, and then the vehicle waiting for entry is allowed to enter the factory area.

In some embodiments, the vehicle order processing method used for an information server may further include followings.

When it is detected that the quantity of an article in the order corresponding to the order number changes, whether the quantity of the article in the order corresponding to the order number is cleared to zero is determined.

Under the condition that the quantity of the article in the order corresponding to the order number is not cleared to zero, a state of the order number is set as valid.

Under the condition that the quantity of the article in the order corresponding to the order number is cleared to zero, the state of the order number is set as invalid.

When it is determined that the order corresponding to the order number is subjected to preset operation, validity of the order number is re-determined. The preset operation includes order modification or order closing. States of an order number with an order which is being modified and an order number with an order which is being closed are both set as invalid, and once it is determined that the order is modified, whether the corresponding order number is valid needs to be determined again.

Optionally, the condition that the order number is valid generally needs to satisfy requirements that the order number is approved and the quantity of the article in the order corresponding to the order number is not cleared to zero, and the condition that the quantity of the article is not cleared to zero means that the preset quantity of the article in the order is greater than the quantity of the incoming or outgoing article.

In some embodiments, before a first confirmation request carrying an order number and sent by a freight forwarder device is received, the method may further include:

the order number is generated according to a preset condition, the preset condition including that procurement is examined and approved and/or delivery is examined and approved, and the order number being configured to trigger the freight forwarder device to send the first confirmation request. In some embodiments, the order number may be notified by enterprise personnel in a communication mode, for example, a telephone to the freight forwarder device, and may also be sent to the freight forwarder device by means of the information server.

In practical application, the information server may be an enterprise internal system, and specifically may be an enterprise resource planning (ERP) system in the enterprise, and vehicle orders for reserving vehicles in the enterprise include two types: delivery vehicles and pickup vehicles. The two orders correspond to a procurement order number (PO number) and a delivery order number (DN number) in the enterprise respectively.

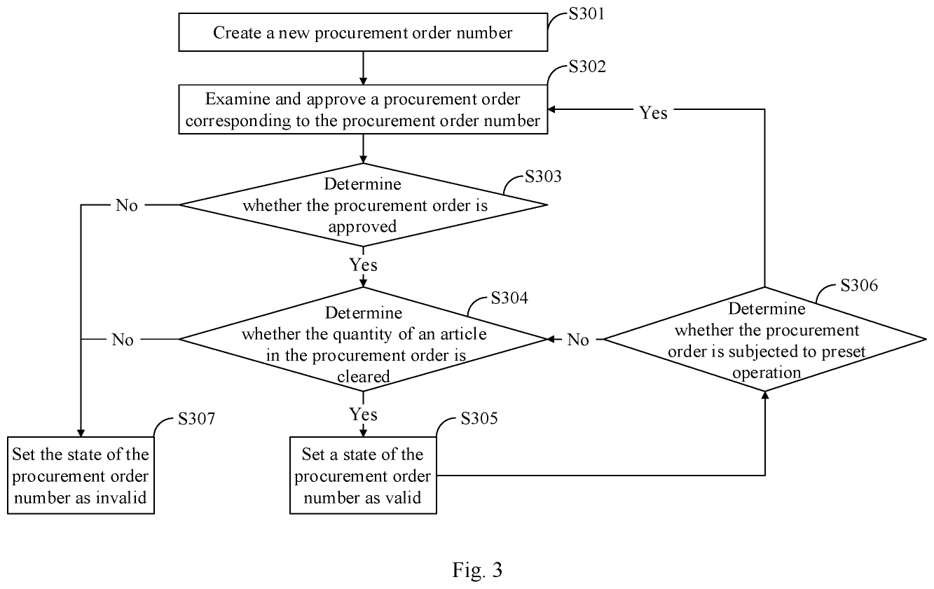

With referent to FIG. 3, as an example, a vehicle order processing method provided in an embodiment of the present disclosure and used for an information server takes a vehicle order as a procurement order, that is, an order number is a procurement order number. The vehicle order processing method includes following steps.

S301, a new procurement order number is created. Optionally, the procurement order number in an enterprise is automatically generated when procurement approval is submitted inside the enterprise.

S302, a procurement order corresponding to the procurement order number is examined and approved. Optionally, in the examination and approval process, a state of the procurement order number is invalid, and under the condition that the procurement order fails to be approved, the state of the procurement order number is still invalid.

S303, whether the procurement order is approved is determined, and if yes, S304 is executed; and if not, S307 is executed.

S304, whether the quantity of an article in the procurement order is cleared to zero is determined, and if yes, S305 is executed; and if not, S307 is executed.

S305, a state of the procurement order number is set as valid.

Optionally, based on S303 and S304, when the procurement is approved and the quantity of the article contained in the procurement order is not cleared to zero (there are goods to enter a factory area), the procurement order number is valid, and a freight forwarder company may use the procurement order number for vehicle reservation.

Optionally, after the procurement order finishes receiving the goods, the ERP system in the enterprise adjusts the quantity of the article in the procurement order, and the actual quantity of the goods not received may be recorded, that is, the quantity of the article required for clearing is recorded.

S306, whether the procurement order is subjected to preset operation is determined, and if yes, S302 is executed; and if not, S307 is executed.

S307, the state of the procurement order number is set as invalid.

Optionally, the preset operation includes order modification or order closing. When the preset operation occurs in the procurement order corresponding to the procurement order number, S302 needs to be re-executed, that is, validity of the procurement order is re-determined, then the state of the procurement order number is re-determined, and the procurement order number is re-set as valid or invalid. Order closing is to cancel the order, and the procurement order number is invalid.

Optionally, the state of the procurement order number is a real-time adjustment and automatic conversion process. Under the condition that the procurement order does not need to continue to receive goods, the quantity of the article in the procurement order corresponding to the procurement order number is cleared to zero, the procurement order number is set as invalid, no additional operation is needed, and the system automatically completes order state conversion. Thus, the driver is unable to reserve factory area entrance with the received procurement order number. Similarly, the valid procurement order is set as valid after being sorted in the ERP system in the enterprise, and the valid procurement order allows a logistics vehicle to enter the factory. After a factory area administrator receives the goods, the ERP system in the enterprise modifies the quantity of the article. Under the condition that the quantity of the article of the procurement order is cleared to zero, the system automatically sets the procurement order number as invalid.

As an example, when the vehicle order is a procurement order, a new procurement order is created by a person in the enterprise, and a state of an order number is invalid when the procurement order number is just generated. The procurement order needs to be examined and approved at an enterprise examination-approval end. Under the condition that the procurement order is in the examination and approval or fails to be approved, the order number is invalid. Under the condition that the procurement order is approved and the procurement order has an unclear quantity (that is, the procurement order has articles needing to enter a factory), the procurement order number is set as valid. After the procurement order receives the goods, the ERP system in the enterprise modifies the state of the order. Under the condition that the unclear quantity still exists, the order number is continuously valid. In the period that the procurement order number is valid, under the condition that order operation, for example, order modification, order closing, etc. exists, the procurement order number is re-determined to be valid. The ERP system in the enterprise may send the procurement order number to a WeChat official account, an applet or other software in the freight forwarder device, and the freight forwarder device may only perform vehicle reservation to form a vehicle order under the condition that the procurement order number is valid. The state of the procurement order number is changed along with the change of a processing state of the procurement order in the ERP system in the enterprise, such that on the premise of saving the labor cost, the safety of factory entrance reservation of the vehicle is greatly improved.

Optionally, the procurement order number may be notified by enterprise personnel in a communication mode, for example, a telephone to the freight forwarder device, and may also be sent to the freight forwarder device by means of the information server.

As an example, when the vehicle order is a delivery order, that is, the order number is a delivery order number, a process principle of the vehicle order processing method is consistent with a process principle when the vehicle order is a procurement order. A new delivery order number is created, and the delivery order number in the enterprise is automatically generated when delivery approval is submitted inside. In the examination and approval process, a state of the delivery order is invalid, and under the condition that the delivery order fails to be approved, the delivery order is still invalid. After the delivery order is approved, goods needing to be delivered are boxed and sorted by a production management department, delivery order information is updated after sorting is completed, in this case, the delivery order is set as valid, and the freight forwarder company may use the order number for vehicle reservation. According to the embodiment of the present disclosure, a random reservation behavior of a driver is greatly avoided in the mode of information interaction with the ERP system in the enterprise, each reservation order may be queried and traced, and the safety risk of the factory area is reduced.

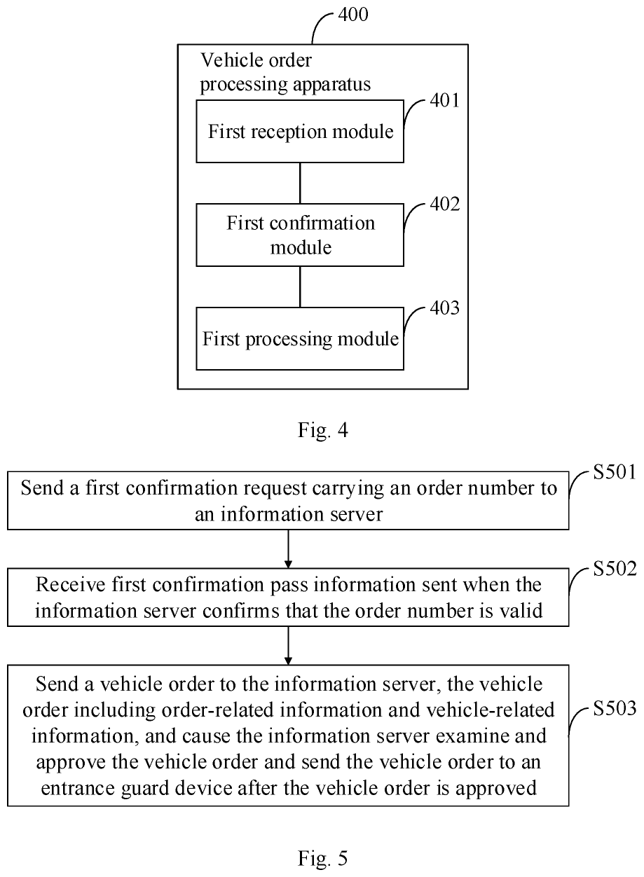

Based on the same inventive concept, an embodiment of the present disclosure further provides a vehicle order processing apparatus used for an information server 101. With reference to FIG. 4, the vehicle order processing apparatus 400 includes:

a first reception module 401 configured to receive a first confirmation request carrying an order number and sent by a freight forwarder device,

a first confirmation module 402 configured to send first confirmation pass information to the freight forwarder device when it is confirmed that the order number is valid,

the first reception module 401 being further configured to receive a vehicle order sent by the freight forwarder device according to the first confirmation pass information, the vehicle order including order-related information and vehicle-related information, and

a first processing module 403 configured to examine and approve the vehicle order, and send the vehicle order to an entrance guard device after the vehicle order is examined and approved.

Optionally, the vehicle order processing apparatus 400 corresponds to the vehicle order processing method used for an information server 101.

Optionally, the vehicle order processing apparatus 400 may further include:

an order number state determination module configured to determine, when it is detected that the quantity of an article in the order corresponding to the order number changes, whether the quantity of the article in the order corresponding to the order number is cleared to zero; set, under the condition that the quantity of the article in the order corresponding to the order number is not cleared to zero, a state of the order number as valid; set, under the condition that the quantity of the article in the order corresponding to the order number is cleared to zero, the state of the order number as invalid; and re-determine, when it is determined that the order corresponding to the order number is subjected to preset operation, validity of the order number, the preset operation including order modification or order closing.

Optionally, the vehicle order processing apparatus 400 may further include:

an order number generation module configured to generate the order number according to a preset condition, the preset condition including that procurement is examined and approved and/or delivery is examined and approved, and the order number being configured to trigger the freight forwarder device to send the first confirmation request.

Optionally, the vehicle order in the vehicle order processing apparatus 400 may further include vehicle reservation person information.

The first processing module 403 is configured to send an examination-approval request to an examination-approval end corresponding to the vehicle reservation person information, and receive an examination and approval result sent by the examination-approval end.

Based on the same inventive concept, an embodiment of the present disclosure further provides a vehicle order processing method used for a freight forwarder device 102. With reference to FIG. 5, the vehicle order processing method includes following steps.

S501, a first confirmation request carrying an order number is sent to an information server.

S502, first confirmation pass information sent when the information server confirms that the order number is valid is received.

Optionally, the first confirmation request includes an order number and may further include order-related information, and the order-related information may include information, for example, a title and an order type.

S503, a vehicle order is sent to the information server, the vehicle order including order-related information and vehicle-related information, and the information server examines and approves the vehicle order and sends the vehicle order to an entrance guard device after the vehicle order is examined and approved.

Optionally, the order-related information in the vehicle order may include an order number, an order title, an order type, the number of order numbers, a cause, etc. The vehicle-related information in the vehicle order may include a logistics company, a driver name, a driver identity card, contact information, a license plate, a vehicle model, an access door, a destination, a deliveryman, an estimated time, etc.

In some embodiments, S501 that a first confirmation request carrying an order number is sent to an information server may include: the order-related information including the order number is received at a first interface, and the first confirmation request is sent based on the order-related information.

S503 that a vehicle order is sent to the information server may include:

when the first confirmation pass information is received, a second interface is displayed, the vehicle-related information is received at the second interface, and

the vehicle order is generated according to the order-related information and the vehicle-related information and is sent.

In some embodiments, an official account client in the freight forwarder device may execute steps of the vehicle order processing method. Optionally, the official account client may be a WeChat official account, applet, or other software.

As an example, in practical application, when a vehicle is needed, the information server sends a corresponding order number to the freight forwarder company, and after receiving the order number, the freight forwarder company makes reservation on the WeChat official account. The WeChat official account uses a layered design, the first layer provides an entry for order number verification, and the second layer provides an entry for specific vehicle-related information. The order number is input into a first interface displayed on the first layer, the WeChat end background interacts with the ERP system in the enterprise, to determine real-time validity of the order. After the validity of the order number passes verification, a second interface is displayed on the second layer. In the second interface, the freight forwarder company may input specific information, for example, the name and contact information of an actual reservation person of the vehicle, a driver, the vehicle, an estimated arrival time, etc., the identity card information of the driver needs to be correctly filled, and the driver needs to enter the factory for registration according to the reservation identity card after arriving at the factory. Finally, a vehicle order is generated after the freight forwarder company confirms the input information.

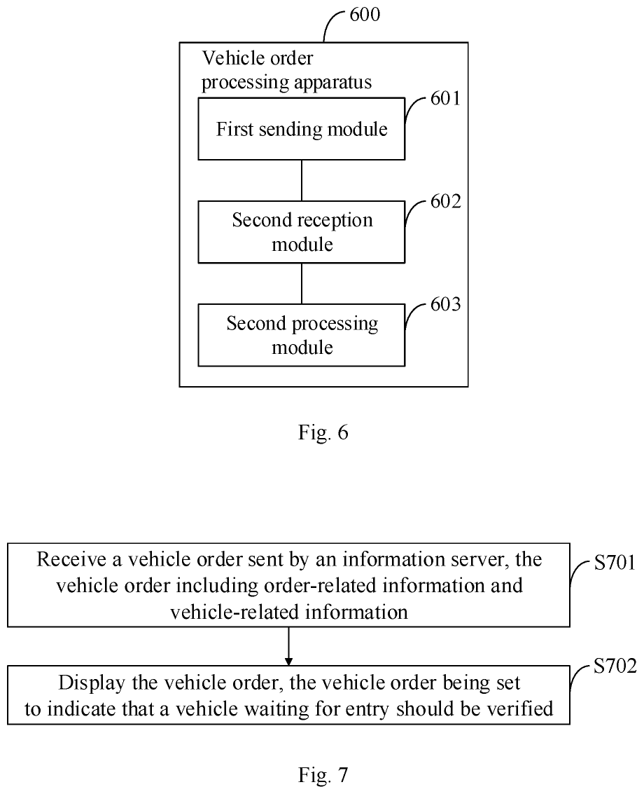

Based on the same inventive concept, an embodiment of the present disclosure further provides a vehicle order processing apparatus used for a freight forwarder device 102. With reference to FIG. 6, the vehicle order processing apparatus 600 includes:

a first sending module 601 configured to send a first confirmation request carrying an order number to an information server;

a second reception module 602 configured to receive first confirmation pass information sent when the information server confirms that the order number is valid; and

a second processing module 603 configured to send a vehicle order to the information server, the vehicle order including order-related information and vehicle-related information; and cause the information server examine and approve the vehicle order and send the vehicle order to an entrance guard device after the vehicle order is examined and approved.

Optionally, the vehicle order processing apparatus 600 corresponds to the vehicle order processing method used for a freight forwarder device 102.

Optionally, the first sending module 601 is specifically configured to receive the order-related information including the order number at a first interface, and send the first confirmation request based on the order-related information; and the second processing module 603 is configured to display a second interface when the first confirmation pass information is received, and receive the vehicle-related information at the second interface; and generate the vehicle order according to the order-related information and the vehicle-related information, and send the vehicle order.

Based on the same inventive concept, an embodiment of the present disclosure further provides a vehicle order processing method, with reference to FIG. 7, which is used for an entrance guard device 103. The vehicle order processing method includes following steps.

S701, a vehicle order sent by an information server is received, the vehicle order including order-related information and vehicle-related information.

Optionally, the vehicle-related information includes a logistics company, a driver name, a driver identity, contact information, a license plate, a vehicle model, an access door, a destination, a deliveryman, an estimated time, etc.

S702, the vehicle order is displayed, the vehicle order being set to show a vehicle waiting for entry should be verified.

Optionally, the verifying a vehicle waiting for entry may be checking according to the information of the displayed vehicle order by an entrance guard. For example, when the driver arrives at the factory area, driver identity card may be scanned so as to confirm that the driver information is consistent with driver information in the vehicle-related information, and then the vehicle waiting for entry is allowed to enter the factory area.

Optionally, under the condition that the order number is invalid, a prompt that the order number is invalid is displayed at a display interface of the entrance guard device, and the vehicle waiting for entry is not allowed to enter the factory area.

In some embodiments, the vehicle order processing method further includes:

vehicle entry-related information is recorded and displayed at a third interface, the vehicle entry-related information including a license plate, a vehicle entering time, a destination of a vehicle and a real-time state of the vehicle.

For example, the vehicle entry-related information is displayed as follows: Wan AD6239 reaches building No. 10 and completes loading of a finished product warehouse with 34 minutes and 41 seconds.

Optionally, the third interface is further configured to display a vehicle situation of the factory area. The vehicle entry-related information may further include: the quantity of the vehicle entering and exiting the factory area, the quantity of the vehicle waiting outside, and a destination and an estimated time of the vehicle waiting for entry.

For example, the vehicle entry-related information is displayed as follows: twelve vehicles are currently in the factory area, twenty-two vehicles are already out of the warehouse area, twenty three vehicles are waiting outside, and Yu LN1120 will arrive at the warehouse of the material database (west) of building No. 3 and will arrive at the factory at Dec. 19, 2019, 10:00.

Optionally, the entrance guard device may display a query box configured to receive a driver identity, an order number, a license plate, or a warehouse for a query at a fourth interface. Further, the entrance guard device carries out classified display on the received vehicle orders at the fourth interface according to preset content, and the preset content includes a security level, urgency, a drafter, a vehicle reservation department, an access storage location, a license plate number, an estimated arrival time and a state. After each vehicle waiting for entry enters the factory area, an actual arrival time is correspondingly recorded and is correspondingly displayed at the fourth interface.

Optionally, the information server sends the approved vehicle order to the entrance guard device, and the entrance guard device may check the vehicle order sent by the information server and confirm whether vehicle reservation is successful by means of the vehicle order.

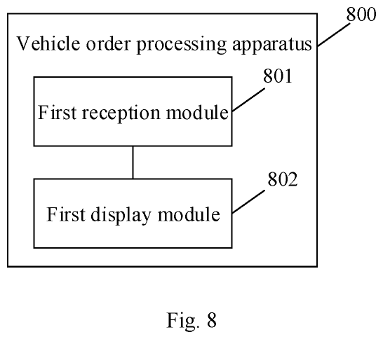

Based on the same inventive concept, an embodiment of the present disclosure further provides a vehicle order processing apparatus. With reference to FIG. 8, the vehicle order processing apparatus 800 includes:

a first reception module 801 configured to receive a vehicle order sent by an information server, the vehicle order including order-related information and vehicle-related information; and

a first display module 802 configured to display the vehicle order, the vehicle order being set to show a vehicle waiting for entry should be verified.

Optionally, the vehicle order processing apparatus 800 corresponds to the vehicle order processing method used for an entrance guard device 103.

Optionally, the vehicle order processing apparatus 800 may further include:

an information display module configured to record vehicle entry-related information, and display the information at a third interface, the vehicle entry-related information including a license plate, a vehicle entering time, a destination of a vehicle and a real-time state of the vehicle.

Optionally, the information display module may be further configured to display a query box configured to receive a driver identity, an order number, a license plate, or a warehouse for a query at a fourth interface, the received vehicle orders are subjected to classified display at the fourth interface according to preset content, the preset content includes a security level, urgency, a drafter, a vehicle reservation department, an access storage location, a license plate number, an estimated arrival time and a state, and the recorded actual arrival time of the vehicle waiting for entering is correspondingly displayed at the fourth interface.

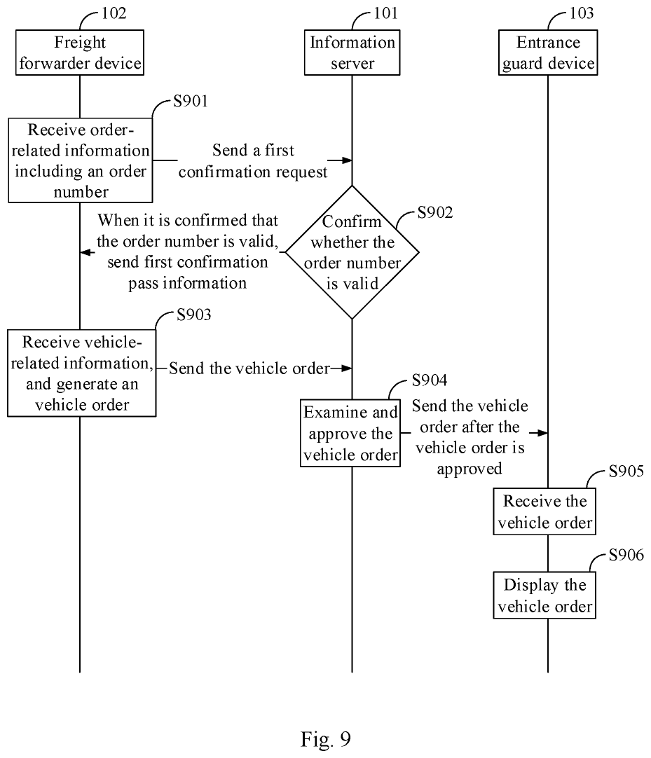

Based on the same inventive concept, an embodiment of the present disclosure further provides a vehicle order processing method used for interaction between an information server 101, a freight forwarder device 102 and an entrance guard device 103. With reference to FIG. 9, the vehicle order processing method includes following steps.

S901, the freight forwarder device 102 receives order-related information including an order number, and sends a first confirmation request to the information server 101.

Optionally, order information is received at a first interface of the freight forwarder device 102, and the first confirmation request is sent based on the order-related information.

S902, when it is confirmed that the order number is valid, the information server 101 sends first confirmation pass information to the freight forwarder device 102.

Optionally, under the condition that it is confirmed that the order number is invalid, the information server 101 sends first confirmation failure information, and when receiving the first confirmation failure information, the freight forwarder device 102 displays prompt information similar to “the order number does not exist, please confirm whether the order number is wrong”.

Optionally, the first confirmation request includes an order number and may further include order-related information, and the order-related information includes a title, an order type, etc.

S903, the freight forwarder device 102 receives the vehicle-related information, generates a vehicle order, and sends the vehicle order to the information server 101.

Optionally, when the first confirmation pass information is received, a second interface is displayed on the freight forwarder device 102; and the second interface receives the vehicle-related information, generates the vehicle order, and sends the vehicle order.

S904, the information server 101 examines and approves the vehicle order, and the vehicle order is sent to the entrance guard device 103 after the vehicle order is approved.

Optionally, under the condition that the vehicle order fails to be approved by the examination-approval end, the information server 101 sends approval failure information to the freight forwarder device 102, and the vehicle order is set as invalid.

S905, the entrance guard device 103 receives the vehicle order sent by the information server 101, the vehicle order including the order number and vehicle-related information.

S906, the entrance guard device 103 displays the vehicle order, the vehicle order being set to show a vehicle waiting for entry should be verified.

Optionally, the entrance guard device 103 may verify the vehicle waiting for entry according to the vehicle-related information of the vehicle order. For example, when a driver arrives at a factory area, a driver identity card may be scanned so as to confirm that the driver information is consistent with driver information in the vehicle-related information, and then the vehicle waiting for entry is allowed to enter the factory area.

According to the embodiment of the present disclosure, the vehicle order processing method used for an information server 101, a freight forwarder device 102 and an entrance guard device 103 includes the content of the embodiment of the vehicle order processing method used for any one of the information server 101, the freight forwarder device 102 or the entrance guard device 103, which will not be repeated herein.

Based on the same inventive concept, an embodiment of the present disclosure further provides an electronic device, including:

a processor;

a memory electrically connected to the processor; and

at least one program stored in the memory and configured to be executed by the processor, the at least one program being configured to implement the vehicle order processing method used for an information server 101, the vehicle order processing method used for a freight forwarder device 102, or the vehicle order processing method used for the entrance guard device 103.

Based on the same inventive concept, an embodiment of the present disclosure further provides a computer-readable storage medium, used for storing a computer instruction, where when running on a computer, the computer instruction implements the vehicle order processing method used for an information server 101, the vehicle order processing method used for a freight forwarder device 102, or the vehicle order processing method used for an entrance guard device 103.

Use of the embodiments of the present disclosure may at least achieve the following beneficial effects.

(1) According to the embodiments of the present disclosure, on the basis of the information server 101, the freight forwarder device 102, and the entrance guard device 103, a safer and faster factory entrance reservation process is provided for logistics vehicles, thereby improving the timeliness, safety, and convenience of logistics vehicle reservations.

(2) According to the embodiments of the present disclosure, the order number may be allowed to initiate order reservation only under the condition that the order number of the information server is valid, that is, a driver may not make reservation to enter a factory area with a previous order number, and vehicles entering the factory area submit vehicle-related information in advance at the information server, so as to avoid the situation that the vehicles which do not make reservation in advance enter the factory area, and compared with other factory entrance reservation modes, the safety risk is greatly reduced under the condition that manpower is not increased.

(3) According to the vehicle order in the embodiments of the present disclosure, the vehicle and the order number are bound and sent to the entrance guard device 103 by means of the information server 101 in advance, such that the order number and vehicle-related information arrive at an entrance guard ahead of the vehicle, information is transmitted in time, and the entrance guard may verify the vehicle waiting for entry according to the vehicle order, such that the technical problem of a tedious process of vehicles entering the factory area in the prior art is solved.

(4) According to the embodiments of the present disclosure, the vehicle order includes vehicle reservation person information, such that the vehicle order may be sent to an examination-approval end corresponding to the vehicle reservation person information according to the vehicle reservation person information. That is, the vehicle order may be directly submitted to an actual reservation person, and the actual reservation person examines and approves the vehicle order, such that invalid operation content is greatly reduced.

(5) According to the embodiments of the present disclosure, the information server 101 sends the order number to the freight forwarder device 102 in advance, and the vehicle order is possibly generated under the condition that the order number is valid, so as to control part of invalid work and reduce the invalid work.

(6) According to the embodiments of the present disclosure, on the basis of three-party linkage and real-time data synchronization of the information server 101, the freight forwarder device 102 and the entrance guard device 103, under the condition that no labor cost is increased, the factory entrance safety risk of the external logistics vehicles is greatly reduced, a factory entrance waiting time of the vehicle is optimized, and thus the factory area business may be carried out more smoothly. This embodiment of the present disclosure does not need to rely on a global positioning system (GPS) and radio frequency identification (RFID) like other technical solutions, is safer and more convenient to operate, and does not generate hardware investment cost.

(7) According to the embodiments of the present disclosure, the state of the order number may be re-determined when it is detected that the quantity of the article in the order corresponding to the order number changes or the order corresponding to the order number is subjected to preset operation, the order number changes along with data change in the information server 101, the state of the order number may be automatically updated, and on the premise of saving the labor cost, the safety of factory entrance reservation of the vehicle is greatly improved.

Those skilled in the art will understand that steps, measures, or solutions of the various operations, methods and flows that have been discussed in the present disclosure may be alternated, altered, combined, or deleted. Further, other steps, measures, or solutions of the various operations, methods and flows that have been discussed in the present disclosure may also be alternated, altered, rearranged, decomposed, combined, or deleted. Further, steps, measures, and solutions of the various operations, methods, and flows in the related art and similar to that disclosed in the present disclosure may also be alternated, altered, rearranged, decomposed, combined, or deleted.

In the description of the present disclosure, it needs to be understood that the orientation or positional relationships indicated by the terms “center”, “up”, “down”, “front”, “rear”, “left”, “right”, “vertical”, “horizontal”, “top”, “bottom”, “inside”, “outside”, etc. are based on the orientation or positional relationship shown in the accompanying drawings, are merely for facilitating the description of the present disclosure and simplifying the description, rather than indicating or implying that an apparatus or element referred to must have a particular orientation or be constructed and operated in a particular orientation, and therefore will not be interpreted as limiting the present disclosure.

The terms “first” and “second” are merely used for describing purposes and cannot be understood as indicating or implying relative importance implicitly indicating the number of indicated technical features. Therefore, the features defined with “first” and “second” can explicitly or implicitly include one or more features. In the description of the present disclosure, the term “a plurality of” means two or more unless otherwise specified.

In the description of the present disclosure, it should be noted that, unless otherwise explicitly specified and defined, the terms “mounting”, “connected” and “connection” should be understood in a broad sense, for example, they may be a fixed connection, a detachable connection, an integrated connection, a direct connection, an indirect connection via an intermediate medium, or communication inside two elements. For those of ordinary skill in the art, the specific meaning of the above terms in the present disclosure can be understood according to specific circumstances.

In the description of the present specification, the particular features, structures, materials, or features can be combined in a suitable manner in any one or more embodiments or examples.

It will be understood that while various steps in the flowcharts of the drawings are shown in sequence as indicated by arrows, the steps are not necessarily performed in sequence in the order indicated by the arrows. The execution of these steps is not strictly limited in order and can be performed in other orders, unless explicitly stated herein. Moreover, at least some steps in the flowcharts of the drawings can include multiple sub-steps or multiple stages that are not necessarily performed simultaneously but can be performed at different moments. These sub-steps or stages are not necessarily executed in sequence, and can be performed along with at least some other steps or sub-steps or stages of other steps in turn or in an alternate manner.

The foregoing is merely some implementation modes of the present disclosure, and it should be noted that several improvements and modifications can also be made by those of ordinary skill in the art without departing from the principles of the present disclosure and should also be considered to fall within the scope of protection of the present disclosure.

1. A vehicle order processing method, applied to an information server and comprising:
receiving a first confirmation request carrying an order number and sent by a freight forwarder device;
sending a first confirmation pass information to the freight forwarder device in response to the order number being determined to be valid;
receiving a vehicle order sent by the freight forwarder device according to the first confirmation pass information, the vehicle order comprising an order-related information and a vehicle-related information; and
examining and approving the vehicle order, and sending the vehicle order to an entrance guard device after the vehicle order is approved.

2. The vehicle order processing method according to claim 1, further comprising:
determining whether a quantity of an article in an order corresponding to the order number is cleared to zero, in response to the quantity of the article changing;
setting a state of the order number as valid in response to the quantity of the article not being cleared to zero;
setting the state of the order number as invalid, in response to the quantity of the article being cleared to zero; and
re-determining validity of the order number in response to the order corresponding to the order number being subjected to preset operation, the preset operation comprising an order modification or an order closing.

3. The vehicle order processing method according to claim 1, wherein before the receiving a first confirmation request carrying an order number and sent by a freight forwarder device, the method further comprises:
generating the order number according to a preset condition, the preset condition comprising that a procurement is approved and/or a delivery is approved, and the order number being configured to trigger the freight forwarder device to send the first confirmation request.

4. The vehicle order processing method according to claim 1, wherein the vehicle order further comprises vehicle reservation person information; and
the examining and approving the vehicle order comprises:
sending an examination-approval request to an examination-approval end corresponding to the vehicle reservation person information, and receiving an examination and approval result sent by the examination-approval end.

5. A vehicle order processing apparatus, applied to an information server and comprising:
a processor;
a memory electrically connected to the processor; and
at least one program stored in the memory,
wherein the processor is configured to read the memory to execute the at least one program to implement the vehicle order processing method according to claim 1.

6. The vehicle order processing apparatus according to claim 5, wherein the processor is configured to read the memory to execute the at least one program to:
determine, in response to the quantity of an article in an order corresponding to the order number changing, whether the quantity of the article is cleared to zero; set a state of the order number as valid in response to the quantity of the article not being cleared to zero; set the state of the order number as invalid in response to the quantity of the article being cleared to zero; and re-determine, in response to the order corresponding to the order number being subjected to preset operation, validity of the order number, the preset operation comprising an order modification or an order closing.

7. The vehicle order processing apparatus according to claim 5, wherein the processor is configured to read the memory to execute the at least one program to:
generate the order number according to a preset condition, the preset condition comprising that a procurement is approved and/or a delivery is approved, and the order number being configured to trigger the freight forwarder device to send the first confirmation request.

8. The vehicle order processing apparatus according to claim 5, wherein the vehicle order further comprises vehicle reservation person information; and
the processor is configured to read the memory to execute the at least one program to send an examination-approval request to an examination-approval end corresponding to the vehicle reservation person information, and receive an examination and approval result sent by the examination-approval end.

9. A vehicle order processing method, applied to a freight forwarder device and comprising:
sending a first confirmation request carrying an order number to an information server;
receiving a first confirmation pass information sent in response to the information server confirming that the order number is valid;
sending a vehicle order to the information server, the vehicle order comprising an order-related information and a vehicle-related information; and causing the information server examine and approve the vehicle order and send the vehicle order to an entrance guard device after the vehicle order is approved.

10. The vehicle order processing method according to claim 9, wherein the sending a first confirmation request carrying an order number to an information server comprises: receiving the order-related information comprising the order number at a first interface, and sending the first confirmation request based on the order-related information; and
the sending a vehicle order to the information server comprises:
in response to the first confirmation pass information being received, displaying a second interface, receiving the vehicle-related information at the second interface,
generating the vehicle order according to the order-related information and the vehicle-related information, and sending the vehicle order.

11. A vehicle order processing apparatus, applied to a freight forwarder device and comprising:
a processor;
a memory electrically connected to the processor; and
at least one program stored in the memory,
wherein the processor is configured to read the memory to execute the at least one program to implement the vehicle order processing method according to claim 9.

12. The vehicle order processing apparatus according to claim 11, wherein the processor is configured to read the memory to execute the at least one program to receive the order-related information comprising the order number at a first interface, and send the first confirmation request based on the order-related information; and
the processor is configured to read the memory to execute the at least one program to display a second interface in response to the first confirmation pass information being received, receive the vehicle-related information at the second interface, generate the vehicle order according to the order-related information and the vehicle-related information, and send the vehicle order.

13. A vehicle order processing method, applied to an entrance guard device and comprising:
receiving a vehicle order sent by an information server, the vehicle order comprising an order-related information and a vehicle-related information; and
displaying the vehicle order, the vehicle order being set to indicate that a vehicle waiting for entry should be verified.

14. The vehicle order processing method according to claim 13, further comprising:
recording a vehicle entry-related information, and displaying the vehicle entry-related information at a third interface, the vehicle entry-related information comprising a license plate, a vehicle entering time, a destination of a vehicle and a real-time state of the vehicle.

15. A vehicle order processing apparatus, applied to an entrance guard device and comprising:
a processor;
a memory electrically connected to the processor; and
at least one program stored in the memory,
wherein the processor is configured to read the memory to execute the at least one program to implement the vehicle order processing method according to claim 13.

16. The vehicle order processing apparatus according to claim 15, wherein the processor is configured to read the memory to execute the at least one program to:
record a vehicle entry-related information, and display the vehicle entry-related information at a third interface, the vehicle entry-related information comprising a license plate, a vehicle entering time, a destination of a vehicle and a real-time state of the vehicle.

17. (canceled)

18. (canceled)

19. (canceled)
